(19) United States
(12) Patent Application Publication
(10) Pub. No.: US 2017/0359821 A1
(43) Pub. Date: Dec. 14, 2017

(54) METHOD AND APPARATUS FOR REUSING OVER OBSS TXOP

(71) Applicant: QUALCOMM Incorporated, San Diego, CA (US)

(72) Inventors: Yan Zhou, San Diego, CA (US); Gwendolyn Denise Barriac, Encinitas, CA (US); Alfred Asterjadhi, San Diego, CA (US); Simone Merlin, San Diego, CA (US); George Cherian, San Diego, CA (US)

(21) Appl. No.: 15/617,809

(22) Filed: Jun. 8, 2017

Related U.S. Application Data
(60) Provisional application No. 62/348,517, filed on Jun. 10, 2016.

(51) Int. Cl. H04W 72/04; H04W 72/12; H04W 74/08; H04W 84/12

(52) U.S. Cl. CPC H04W 72/0446; H04W 74/0816; H04W 72/121; H04W 84/12

(57) ABSTRACT

Reuse of transmission resources is discussed in which a transmitting node may reuse an entire remaining overlapping basic service set (OBSS) transmission opportunity (TXOP) instead of being limited to reuse based on a per-frame basis. The node may reuse the remaining TXOP if the expected caused interference to other nodes using the resources is below a predetermined threshold. Spatial reuse information may be classified into different mode based on the manner in which the spatial reuse information is obtained by the transmitting node. The manner in which the expected caused interference may be determine may be associated with the particular spatial reuse mode.

### CROSS-REFERENCE TO RELATED APPLICATIONS

The present application claims priority to co-pending U.S. Provisional Patent Application No. 62/348,517, entitled “METHOD AND APPARATUS FOR REUSING OVER OBSS TXOP”, filed Jun. 10, 2016, the disclosure of which is hereby incorporated herein by reference.

### BACKGROUND

### Field

The following relates generally to wireless communication and more specifically to reusing over overlapping basic service set (OBSS) frame(s) in a transmission opportunity (TXOP).

### Background

Wireless communications systems are widely deployed to provide various types of communication content such as voice, video, packet data, messaging, broadcast, and so on. These systems may be multiple-access systems capable of supporting communication with multiple users by sharing the available system resources (e.g., time, frequency, and power). A wireless network, for example a wireless local area network (WLAN), such as a Wi-Fi (i.e., IEEE 802.11) network may include access point (AP) that may communicate with one or more stations (STAs) or mobile devices. The AP may be coupled to a network, such as the Internet, and may enable a mobile device to communicate via the network (or communicate with other devices coupled to the access point). A wireless device may communicate with a network device bi-directionally. For example, in a WLAN, an STA may communicate with an associated AP via downlink (DL) and uplink (UL). The DL (or forward link) may refer to the communication link from the AP to the station, and the UL (or reverse link) may refer to the communication link from the station to the AP.

A group of STAs that are communicating with an AP may be known as a basic service set (BSS). In some cases, the area of one BSS may overlap with the area of another BSS, which may be known as an OBSS. Transmissions from different devices within the OBSS may interfere with one another. Techniques used by each device to limit this interference, such as OBSS frame reusing rules, may limit the efficiency of communications within the OBSS.

### SUMMARY

In one aspect of the disclosure, a method of wireless communication includes obtaining spatial reuse (SR) information from one or more nodes, performing a reuse check based on the obtained SR information for a transmission opportunity, wherein the performing includes determining whether the reuse check passes for at least one overlapping basic service set (OBSS) frame in the transmission opportunity based on at least one predetermined level in the obtained SR information, and reusing one or more remaining OBSS frames of the transmission opportunity after the at least one OBSS frame and any portion of the at least one OBSS frame after the determining the reuse check passes in response to the determining that the reuse check passes for the at least one OBSS frame.

In an additional aspect of the disclosure, an apparatus configured for wireless communication includes means for obtaining SR information from one or more nodesr, means for performing a reuse check based on the obtained SR information for a transmission opportunity, wherein the means for performing includes means for determining whether the reuse check passes for at least one OBSS frame in the transmission opportunity based on at least one predetermined level in the obtained SR information, and means for reusing one or more remaining OBSS frames of the transmission opportunity after the at least one OBSS frame and any portion of the at least one OBSS frame after the means for determining the reuse check passes in response to determination that the reuse check passes for the at least one OBSS frame.

In an additional aspect of the disclosure, a non-transitory computer-readable medium having program code recorded thereon. The program code further includes code to obtain SR information from one or more nodes, code to perform a reuse check based on the obtained SR information for a transmission opportunity, wherein the code to perform includes code to determine whether the reuse check passes for at least one OBSS frame in the transmission opportunity based on at least one predetermined level in the obtained SR information, and code to reuse one or more remaining OBSS frames of the transmission opportunity after the at least one OBSS frame and any portion of the at least one OBSS frame after execution of the code to determine the reuse check passes in response to determination that the reuse check passes for the at least one OBSS frame.

In an additional aspect of the disclosure, an apparatus configured for wireless communication is disclosed. The apparatus includes at least one processor, and a memory coupled to the processor. The processor is configured to obtain SR information from one or more nodes, to perform a reuse check based on the obtained SR information for a transmission opportunity, wherein the configuration to perform includes configuration of the at least one processor to determine whether the reuse check passes for at least one OBSS frame in the transmission opportunity based on at least one predetermined level in the obtained SR information, and to reuse one or more remaining OBSS frames of the transmission opportunity after the at least one OBSS frame and any portion of the at least one OBSS frame after execution of the configuration to determine the reuse check passes in response to determination that the reuse check passes for the at least one OBSS frame.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purpose of illustration and description, and not as a definition of the limits of the claims.

### BRIEF DESCRIPTION OF THE DRAWINGS

A further understanding of the nature and advantages of the present disclosure may be realized by reference to the following drawings. In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label.

FIG. 1 illustrating details of a WLAN for wireless communications.

FIG. 2 illustrates an example of a wireless communications system with OBSS.

FIG. 3 illustrates details of a TXOP.

FIG. 4 is a block diagram illustrating example blocks executed to implement one aspect of the present disclosure regarding reusing over OBSS TXOP.

FIG. 5 illustrates details of a TXOP in accordance with one aspect of the present disclosure.

FIG. 6 illustrates details of a TXOP in accordance with one aspect of the present disclosure.

FIG. 7 illustrates details of a TXOP in accordance with one aspect of the present disclosure.

FIG. 8 illustrates details of a TXOP in accordance with one aspect of the present disclosure.

FIG. 9 illustrates details of a TXOP in accordance with one aspect of the present disclosure.

FIG. 10 illustrates a block diagram of a reusing node in accordance with one aspect of the present disclosure.

### DETAILED DESCRIPTION

In some wireless communications systems, a transmitting wireless device such as a station (STA) or an access point (AP) that is part of a basic service set (BSS) may perform a clear channel assessment (CCA) procedure to determine the availability of the radio frequency spectrum used for communication. Multiple BSSs can be in relative close proximity, and transmissions from an overlapping BSS (OBSS) may impact the ability of a device to obtain access to, or “win,” the channel. For example, if an STA detects a packet (e.g., a preamble) from another device, the STA may abstain from transmitting for the duration of the detected packet if the receive power of the packet is above a threshold. However, if the STA detects a packet from another device, it may still transmit if the received power of the packet is less than a threshold. In some cases, an STA may increase the threshold if the STA's transmission (TX) power is correspondingly decreased by some amount.

During a transmission opportunity (TXOP) that includes one or more OBSS frames, transmissions from multiple transmitting wireless devices may overlap. Conventionally, in order to reduce interferences, a transmitting wireless device (i.e., reusing device) may perform a CCA procedure for each OBSS frame to determine whether it is reusable. After performing such a reuse check, the reusing node may be able to use the remaining time of the “checked” OBSS frame. However, if a TXOP includes more than one OBSS frame, the transmitting wireless device may have to perform a reuse check, perform the reuse, and terminate reusing for each of the OBSS frames in TXOP. In this case, inefficiencies result, and a time gap between termination of reuse and start of reusing a following OBSS frame may further reduce a reuse gain. The present disclosure addresses this problem by enabling more than one OBSS frame to be reused based on a reuse check of one OBSS frame within a TXOP. By reusing the remaining OBSS TXOP instead of performing a reuse check per OBSS frame, the reuse gain can be improved due to longer continuous reuse time since the reuse check may be bypassed for remaining OBSS frames in the TXOP.

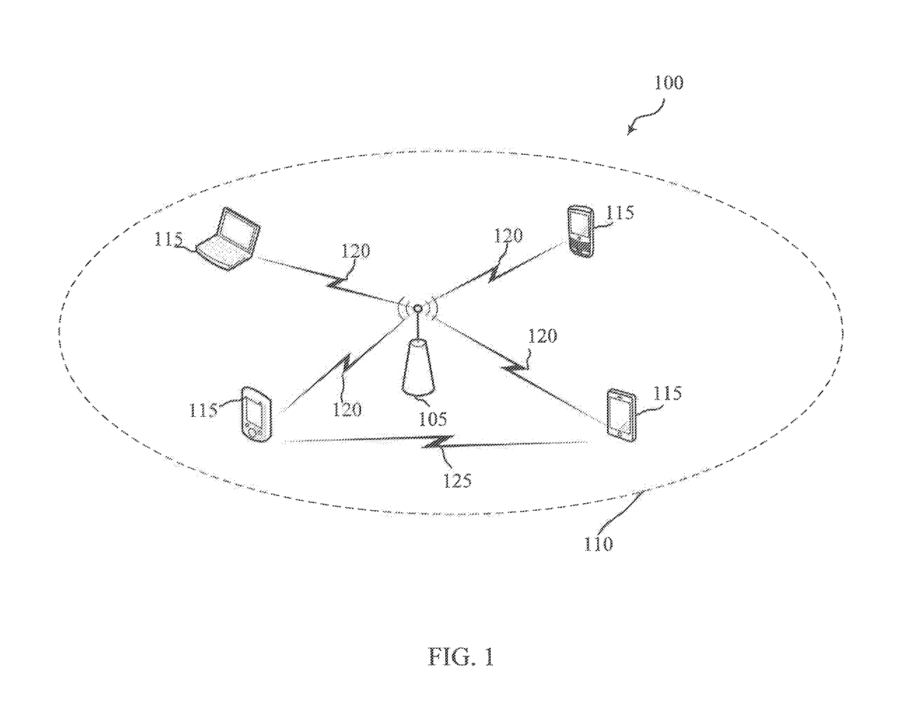

FIG. 1 illustrating details of a WLAN 100 for wireless communications. WLAN 100 may be a Wi-Fi network. WLAN 100 may include an AP 105 and multiple associated STAs 115, which may represent devices such as mobile stations, personal digital assistants (PDAs), other handheld devices, netbooks, notebook computers, tablet computers, laptops, display devices (e.g., TVs, computer monitors, etc.), printers, etc. AP 105 and the associated STAs 115 may represent a BSS or an extended service set (ESS). The various STAs 115 in the network are able to communicate with one another through AP 105. Also shown is a coverage area 110 of the AP 105, which may represent a basic service area (BSA) of WLAN 100. An extended network station (not shown) associated with WLAN 100 may be connected to a wired or wireless distribution system that may allow multiple APs 105 to be connected in an ESS.

Although not shown in FIG. 1, STA 115 may be located in the intersection of more than one coverage area 110 and may associate with more than one AP 105. A single AP 105 and an associated set of STAs 115 may be referred to as a BSS. An ESS is a set of connected BSSs. A distribution system (not shown) may be used to connect APs 105 in an ESS. In some cases, coverage area 110 of AP 105 may be divided into sectors (also not shown). WLAN 100 may include APs 105 of different types (e.g., metropolitan area, home network, etc.), with varying and overlapping coverage areas 110. Two STAs 115 may also communicate directly via a direct wireless link 125 regardless of whether both STAs 115 are in the same coverage area 110. Examples of direct wireless links 125 may include Wi-Fi Direct connections, Wi-Fi Tunneled Direct Link Setup (TDLS) links, and other group connections. STAs 115 and APs 105 may communicate via a wireless link 120 according to the WLAN radio and baseband protocol for physical (PHY) and medium access control (MAC) layers from IEEE 802.11 and versions including, but not limited to, 802.11b, 802.11g, 802.11a, 802.11n, 802.11ac, 802.11ad, 802.11ah, etc. In other implementations, peer-to-peer connections or ad hoc networks may be implemented within WLAN 100. In further implementations, WLAN 100 may be controlled by wide wireless access network (WWAN), such as a LTE network.

In some cases, STA 115 or AP 105 may operate in a shared or unlicensed frequency spectrum. These devices may perform a CCA prior to communicating in order to determine whether the channel is available. A CCA may include an energy detection procedure to determine whether there are any other active transmissions. For example, the device may infer that a change in a received signal strength indication (RSSI) of a power meter indicates that a channel is occupied. Specifically, signal power is that is concentrated in a certain bandwidth and exceeds a predetermined noise floor may indicate another wireless transmitter. A CCA may also include detection of specific sequences that indicate use of the channel. For example, another device may transmit a specific preamble prior to transmitting a data sequence.

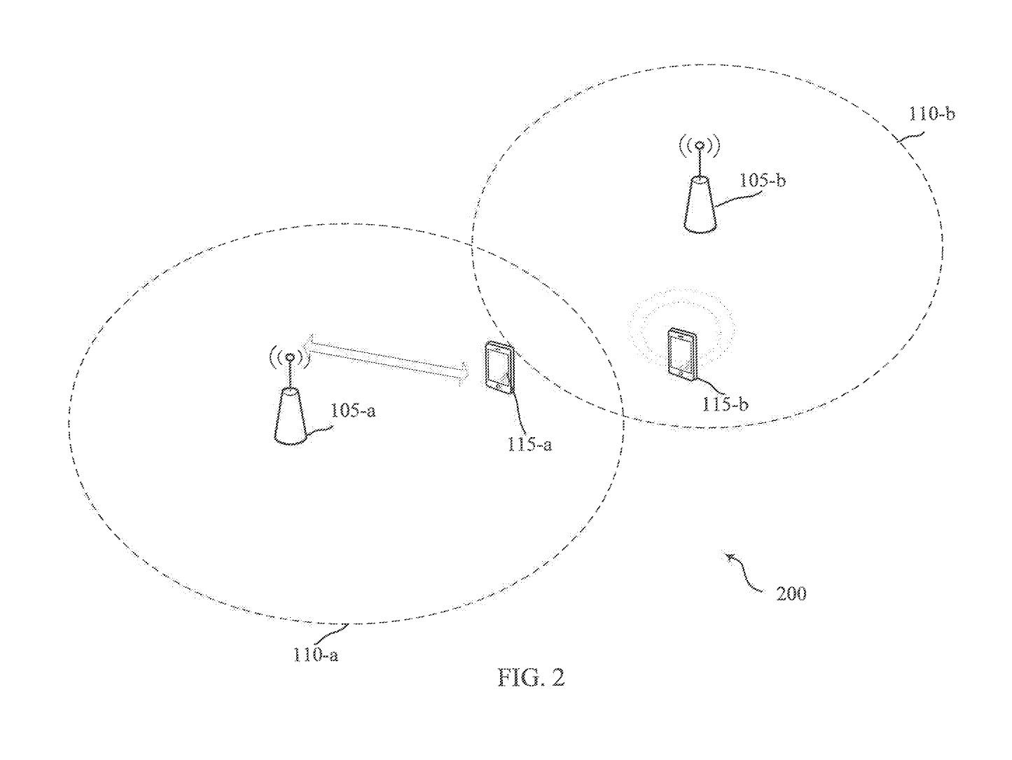

FIG. 2 illustrates an example of a wireless communications system 200 with OBSS. Wireless communications system 200 may include AP 105-a and STA 115-a associated with a first BSS with a coverage area 110-a. Wireless communications system 200 may also include AP 105-b and STA 115-b, which may be associated with an OBSS having a coverage area 110-b that overlaps coverage area 110-a. AP 105-a, AP 105-b, STA 115-a, and STA 115-b may all communicate with one another and may be examples of the corresponding devices described with reference to FIG. 1. The examples described below with reference to STA 115 may be performed by any number of wireless devices.

In wireless communications system 200, a transmitting wireless device (e.g., STAs 115-a, 115-b or AP 105-a, 105-b) may perform a CCA procedure to determine the availability of the radio frequency spectrum used for communication. In some cases, multiple BSSs can be in relative close proximity, and interference from STA 115-b may affect the transmission of STA 115-a. STA 115-a may detect a preamble from STA 115-b and determine whether to transmit. The preamble may include spatial reuse (SR) information. SR information may be obtained by decoding the detected preamble. SR information may include a predetermined CCA level, or a predetermined interference level. If STA 115-a detects the SR information from STA 115-b, STA 115-a may refrain from transmitting if a received RSSI is above the predetermined CCA level, and/or if an estimated interference to STA 115-b is above the predetermined interference level. The interference to STA 115-b may be estimated based on path loss measured by STA 115-a. However, STA 115-a may proceed with transmitting if a received RSSI is below the predetermined CCA level, and/or if an estimated interference to STA 115-b is below the predetermined interference level.

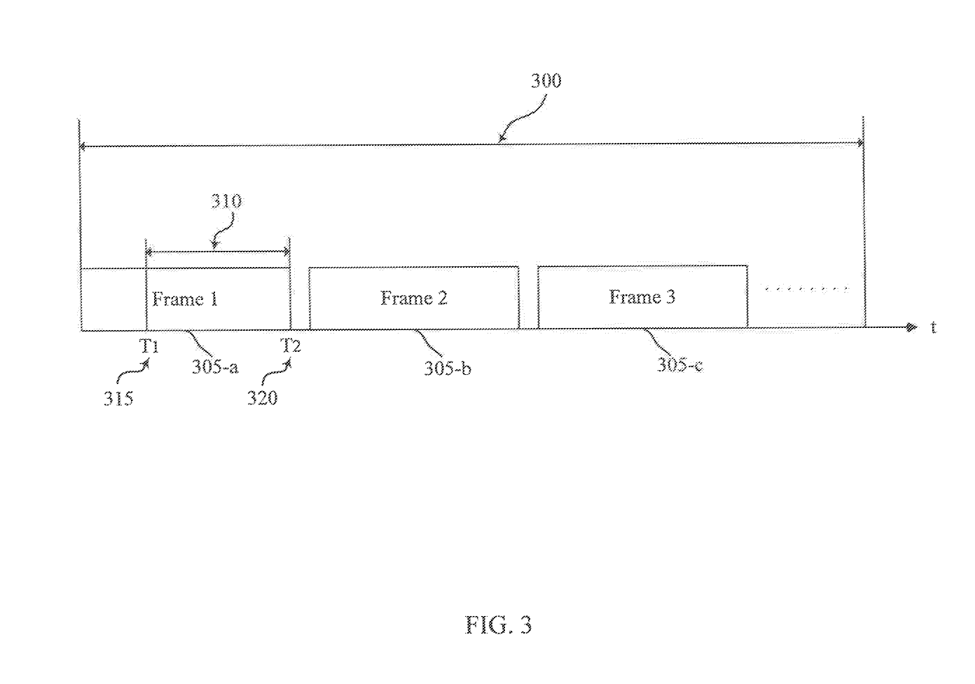

FIG. 3 illustrates details of a transmission opportunity (TXOP) 300. TXOP 300 may include one or more OBSS frames 305-a, 305-b, 305-c . . . . During TXOP 300, transmissions from multiple transmitting wireless devices may overlap. Conventionally, in order to reduce interferences, a transmitting wireless device may perform a CCA procedure for each of OBSS frames 305-a, 305-b, 305-c . . . to determine whether to transmit in such OBSS frame. In other words, a transmitting wireless device may perform a CCA procedure for each of frames 305-a, 305-b, 305-c . . . to determine whether it is reusable. Accordingly, a transmitting wireless device may also be referred to as a reusing node herein. After performing a CCA procedure/reuse check, a transmitting wireless device/reusing node may be able to use the remaining time of such “checked” OBSS frame. For example, if a reuse check is performed for OBSS frame 305-a, and such reuse check is completed at T₁ 315, a reusing node may be only able to reuse a time period 310 between T₁ 315 and T₂ 320 within OBSS frame 305-a. Still further, if a TXOP includes more than one OBSS frame, such as TXOP 300 in FIG. 3, the transmitting wireless device may have to perform a reuse check, perform the reuse, and terminate reusing for each of the OBSS frames in TXOP, further compounding the inefficiencies associated with limited reuse time period due to performing reuse check. A time gap between termination of reuse and start of reusing a following OBSS frame may reduce a reuse gain. As a result, overall communication efficiency may degrade.

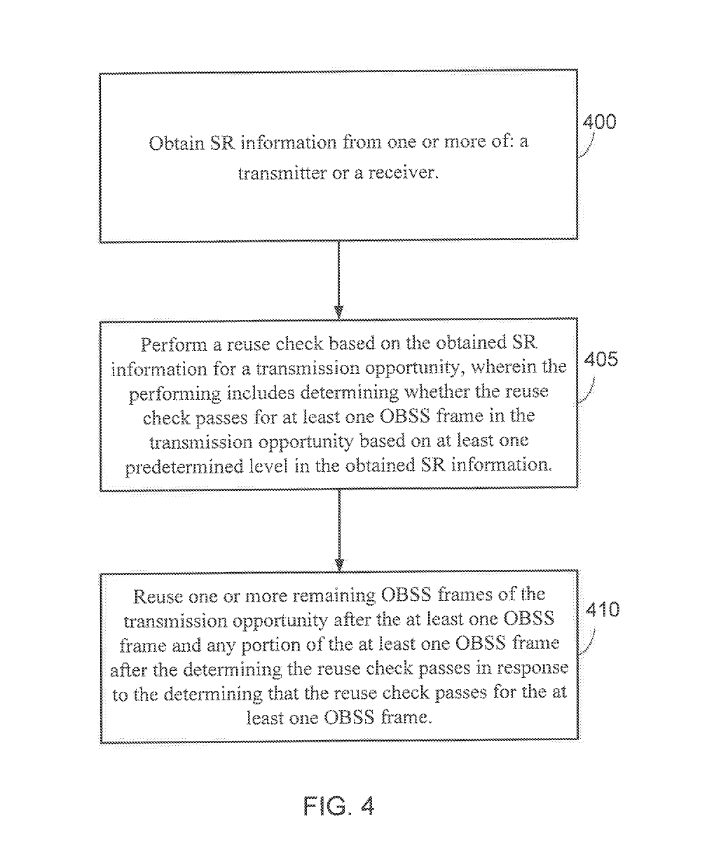

In some instances, as described in further detail below with respect to FIG. 4, more than one OBSS frame may be reused based on a reuse check of one OBSS frame within a TXOP. In other words, a reusing node may perform a reuse check of one OBSS frame within a TXOP, and reuse the entire remaining OBSS TXOP instead of reusing just the one OBSS frame for which the reuse check was performed. In other instances, one or more reuse checks may be performed for one or more OBSS frames, but any number of OBSS frames after completion of the reuse check(s) remaining within the TXOP may be reused. By reusing the remaining OBSS TXOP instead of performing a reuse check per OBSS frame, the reuse gain can be improved due to longer continuous reuse time since the reuse check may be bypassed for remaining OBSS frames in the TXOP.

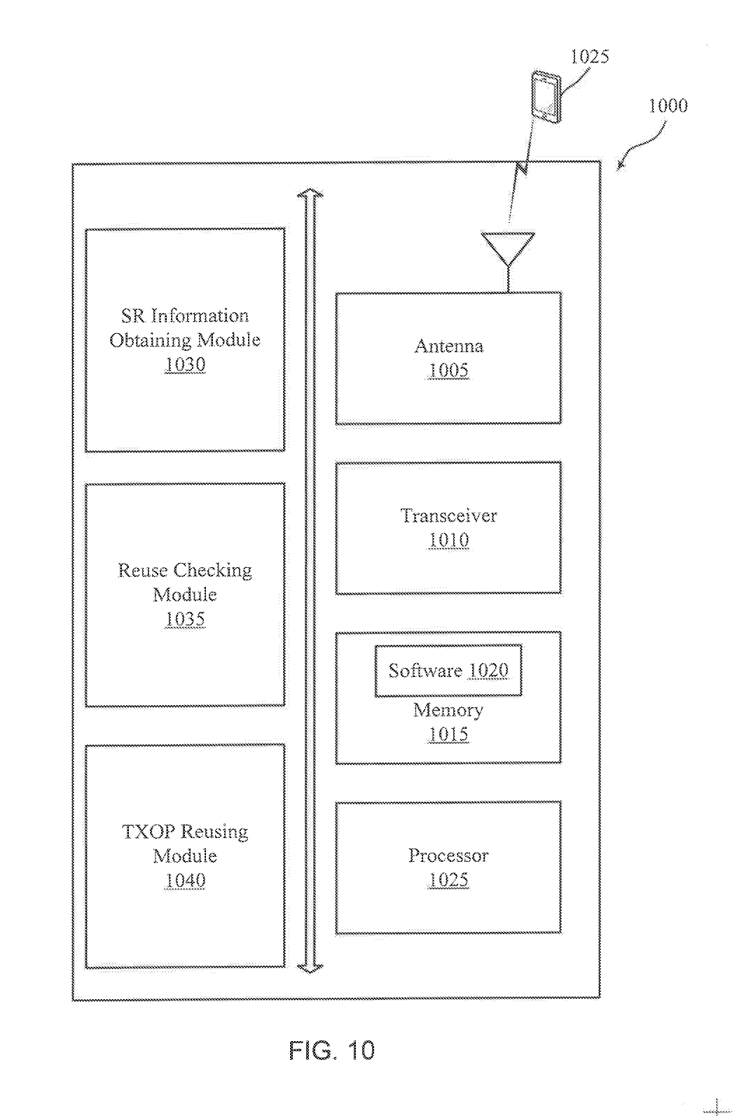

FIG. 4 is a block diagram illustrating example blocks executed to implement one aspect of the present disclosure regarding reusing over OBSS TXOP. The example blocks may be implemented by a reusing node, such as APs 105 and STAs 115 in FIGS. 1, 2 and 10. The reusing node, as illustrated in FIG. 10, may include a processor 1025, which operates to execute logic, computer instructions, software 1020 stored in a memory 1015, an antenna 1005 to transmit/receive signals, and a transceiver 1010 to process signals. At block 400, spatial reuse (SR) information may be obtained from one or more nodes, which may be an access point, or a station, such as APs 105 and STAs 115 in FIGS. 1 and 2. At block 405, a reuse check may be performed based on the obtained SR information for a transmission opportunity. The reuse check may help a reusing node to determine one or more distances with respect to soliciting and responding nodes, and determine whether to transmit/reuse OBSS frames in TXOP accordingly. Performing the reuse check may include determining whether the reuse check passes for at least one overlapping basic service set (OBSS) frame in the transmission opportunity based on at least one predetermined level in the obtained SR information. At block 410, in response to the determining that the reuse check passes for the at least one OBSS frame, one or more remaining OBSS frames of the transmission opportunity after the at least one OBSS frame and any portion of the at least one OBSS frame after the determining the reuse check passes may be reused.

The predetermined level may be one or more of: a clear channel assessment (CCA) level, or an interference level. Accordingly, determining whether the reuse check passes for the at least one OBSS frame may include determining a received signal strength indicator (RSSI), and/or determining an estimated interference to one or more neighboring nodes by a reusing node, and comparing them with the predetermined level. In some cases, a reuse check may pass when an RSSI is below a predetermined CCA level. In other cases, a reuse check may pass when an estimated interference is below a predetermined interference level. Oppositely, a reuse check may not pass when an RSSI is above a predetermined CCA level, or when an estimated interference is above a predetermined interference level.

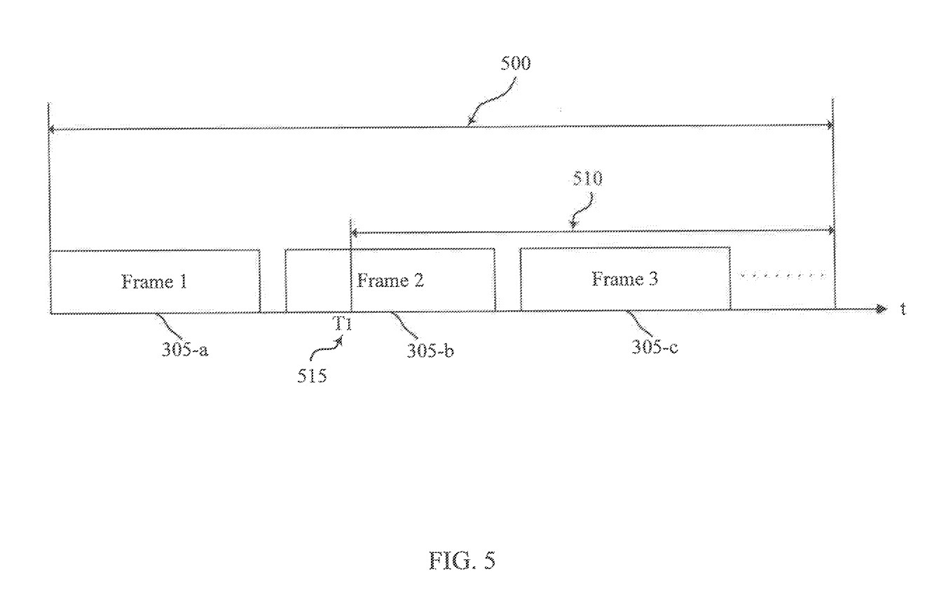

FIG. 5 illustrates details of a TXOP 500 in accordance with one aspect of the present disclosure. The same as TXOP 300 in FIG. 3, TXOP 500 also includes one or more OBSS frames 305-a, 305-b, 305-c . . . . In some aspects of the present disclosure, the duration of TXOP 500 may be determined based on a network allocation vector (NAV). The NAV may be obtained by a reusing node from the received SR information. In TXOP 500, reusing procedures as provided in FIG. 4 are implemented. As a result, the entire duration of TXOP 510 after a reuse check is completed at T₁ 515 may be reused by a reusing node. Such duration 510 may include one or more OBSS frames after the “checked” OBSS frame, such as frame 305-c, and any remaining time of the OBSS frame after the completion of reuse check, such as remaining time of frame 305-b after T₁ 515. The reuse check may include one or more reuse checks for one or more OBSS frames in TXOP 500. Accordingly, a reusing node may have longer continuous reuse time.

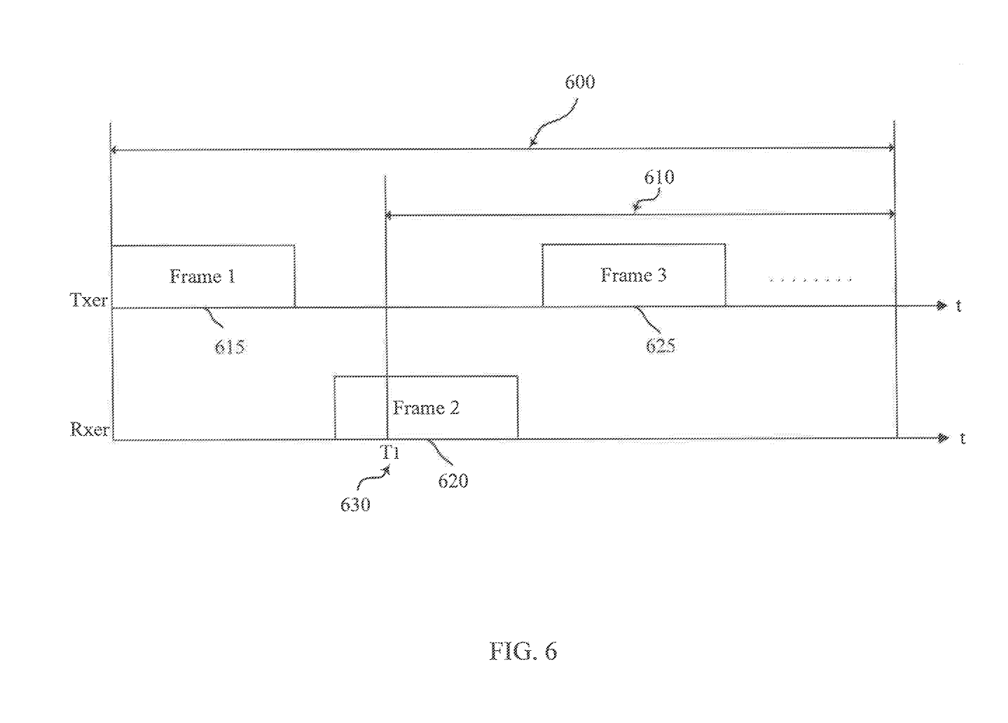

The reusing methods and concepts as provided above and FIGS. 4 and 5 may be applicable to different types of communication structure, such as single user communications, or multiple users communications. Single user communications may involve two different nodes that exchange transmissions in OBSS frames, such as a soliciting node, which is also referred to as a transmitter, and a responding node, which is also referred to as a receiver. Multiple user communications may involve more nodes that exchange transmissions in OBSS frames, such as multiple soliciting nodes and multiple responding nodes, a soliciting node and multiple responding nodes, or multiple soliciting nodes and a responding node. A reusing node may detect and measure signals simultaneously transmitted from multiple nodes. The reusing methods and concepts as provided above and FIGS. 4 and 5 may be also applicable to different types of transmission modes. Exemplary transmission modes and corresponding reusing methods are illustrated below with FIGS. 6-9.

FIG. 6 illustrates details of a TXOP 600 in accordance with one aspect of the present disclosure. TXOP 600 may include one or more OBSS frames. In TXOP 600, a node may transmit a frame 615, and another node may transmit a frame 620. The nodes may be APs 105, or STAs 115 as provided in FIGS. 1 and 2, or any other network devices capable of transmitting and receiving signals, information, or data. In Mode 1, frame 615 may be an enhanced request to send (e-RTS) frame, and frame 620 may be an enhanced clear to send (e-CTS) frame. Compared with legacy RTS/CTS, e-RTS/e-CTS carries spatial reuse (SR) information to guide reusing node for reuse decision. In an e-RTS frame, a soliciting node may transmit SR information at the transmitter side. In e-CTS frame, a responding node may transmit SR information at receiver side. In order to determine whether to transmit in TXOP 600, a reusing node for Mode 1 may obtain SR information from both nodes on frame 615 and frame 620, and perform a reuse check for both frame 615 and frame 620. A reusing node may reuse a duration 610 in response to the determining the reuse check passes for both frame 615 and frame 620. Duration 610 may start from T₁ 630, at which a reuse check is determined to pass, and end at the end of TXOP 600. Alternatively, duration 610 may end before the end of TXOP 600 in accordance with the obtained SR information. Duration 610 may include the remaining time period in frame 620 after completion of the reuse check at T₁ 630, and any subsequent OBSS frames in TXOP 600, such as frame 625 and OBSS frames after frame 625. In some cases, the reuse check may only pass for frame 620. In response to such reuse checking results, a reusing node may only reuse OBSS frames transmitted by the soliciting node, which is typically right after frame 620, such as frame 625.

In Mode 2, frame 615 may be a trigger frame, and frame 620 may be a legacy clear to send (L-CTS) frame, or a data frame. In the trigger frame, a soliciting node may transmit information to another node to solicit the receiver's response or data transmissions. A trigger frame may be an e-RTS frame, a frame trigger data transmissions, or a data frame. In the L-CTS frame, the responding node may transmit L-CTS information, which does not include the SR information. In order to determine whether to transmit in TXOP 600, a reusing node for Mode 2 may obtain SR information from the soliciting node on frame 615, perform a reuse check for frame 620, and perform an additional check for frame 615.

The additional check may be performed by obtaining at least one threshold, such as a CCA threshold, or an interference threshold, and comparing such threshold to an RSSI of the trigger frame, or an estimated interference to the sender of frame 615. In some cases, an additional check for frame 615 may pass when an RSSI of frame 615 is below a predetermined CCA threshold. In other cases, an additional check for frame 615 may pass when an estimated interference to the sender of frame 615 is below a predetermined interference threshold. Oppositely, an additional check may not pass when an RSSI of frame 615 is above a predetermined CCA threshold, or when an estimated interference to the sender of frame 615 is above a predetermined interference threshold. The threshold may be obtained from received SR information, or a preamble of frame 615, or determined by a reusing node.

A reusing node may reuse duration 610 in response to the determining the reuse check passes for frame 620, and the additional check passes for frame 615. Duration 610 may start from T₁ 630, at which a reuse check is determined to pass, and end at the end of TXOP 600. Alternatively, duration 610 may end before the end of TXOP 600 in accordance with the obtained SR information. Duration 610 may include the remaining time period in frame 620 after the completion of reuse check, and any subsequent OBSS frames in TXOP 600, such as frame 625 and OBSS frames after frame 625. In some aspects of the present disclosure, a reusing node may simultaneously receive L-CTS frames from multiple nodes. Accordingly, the reusing mode may perform a reuse check for all of such multiple L-CTS frames from multiple nodes.

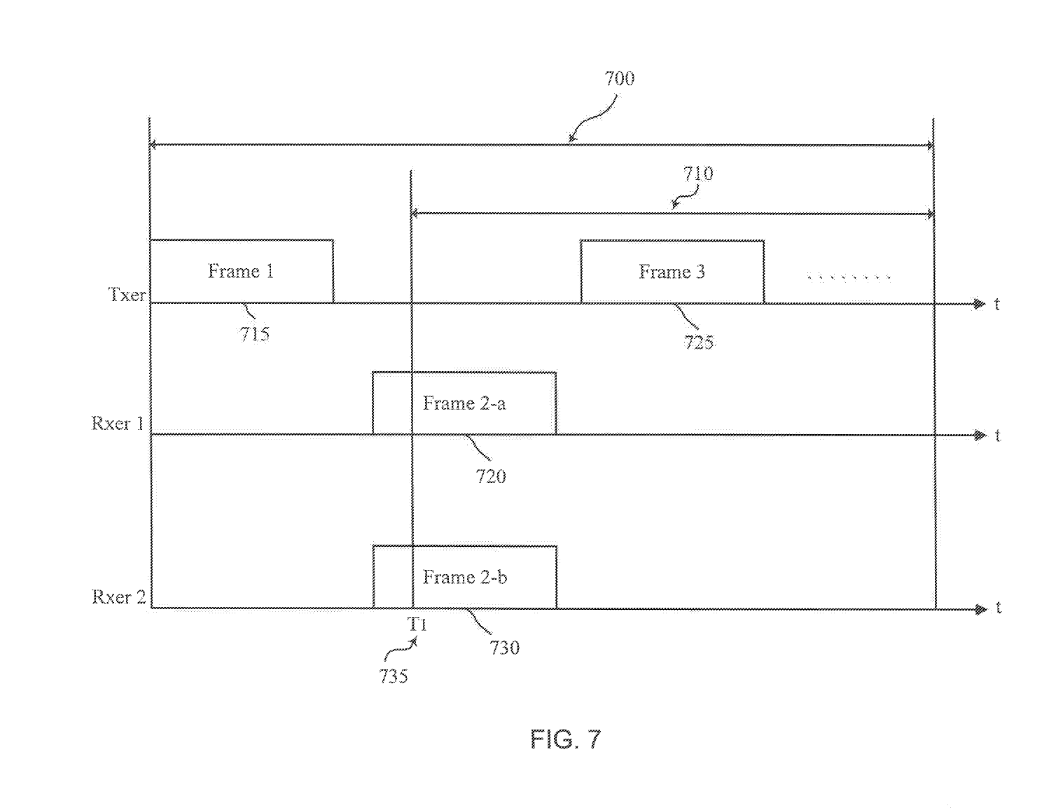

FIG. 7 illustrates details of a TXOP 700 in accordance with one aspect of the present disclosure. TXOP 700 may include one or more OBSS frames. In TXOP 700, a soliciting node (Txer) may transmit a frame 715, a first responding node (Rxer 1) and a second responding node (Rxer 2) may transmit frames 720 and 730 simultaneously. Txer, Rxer 1, and Rxer 2 may be APs 105, or STAs 115 as provided in FIGS. 1 and 2, or any other network devices capable of transmitting and receiving signals, information, or data. In Mode 3, frame 715 may be a trigger frame, and frames 720 and 730 may be solicited frames. A trigger frame may be an e-RTS frame, a frame trigger data transmissions, or a normal data frame. A solicited frame may be a L-CTS frame, a legacy acknowledge frame, or a data frame. In order to determine whether to transmit in TXOP 700, a reusing node for Mode 3 may obtain SR information from the soliciting node on frame 715, perform a reuse check for the frame 715, and perform an additional check for frames 720 and 730.

The additional check may be performed by obtaining at least one threshold, such as a CCA threshold, or an interference threshold, and comparing such threshold with an aggregated RSSI of frames 720 and 730, or an estimated individual or total interference to the senders of frames 720 and 730. In some cases, an additional check for frames 720 and 730 may pass when the aggregated RSSI of frames 720 and 730 are below a predetermined CCA threshold. In other cases, an additional check for frames 720 and 730 may pass when an estimated individual or total interference to the senders of the frames 720 and 730 are below a predetermined interference threshold. Oppositely, an additional check may not pass when the aggregated RSSI of frames 720 and 730 are above a predetermined CCA threshold, or when an estimated interference to the senders of frames 720 and 730 is above a predetermined interference threshold. The threshold may be obtained from received SR information, a preamble of frame 715, or preambles of frames 720 and 730, or determined by a reusing node.

A reusing node my reuse duration 710 in response to the determining the reuse check passes for frame 715, and the additional check passes for frames 720 and 730. Duration 710 may start from T₁ 735, at which both a reuse check and an additional check are determined to pass, and end at the end of TXOP 700. Alternatively, duration 710 may end before the end of TXOP 700 in accordance with the obtained SR information. Duration 710 may include the remaining time period in frames 720 and 730 after the completion of reuse check and additional check, and any subsequent OBSS frames in TXOP 700, such as frame 725 and OBSS frames after frame 725.

In Mode 3, since multiple nodes may transmit solicited frames at the same time, such as second frames 720 and 730, a reusing node may calculate an RSSI, and/or estimate an individual or total interference to such nodes based on the aggregated RSSI received from such nodes, and/or path loss of signals from such nodes.

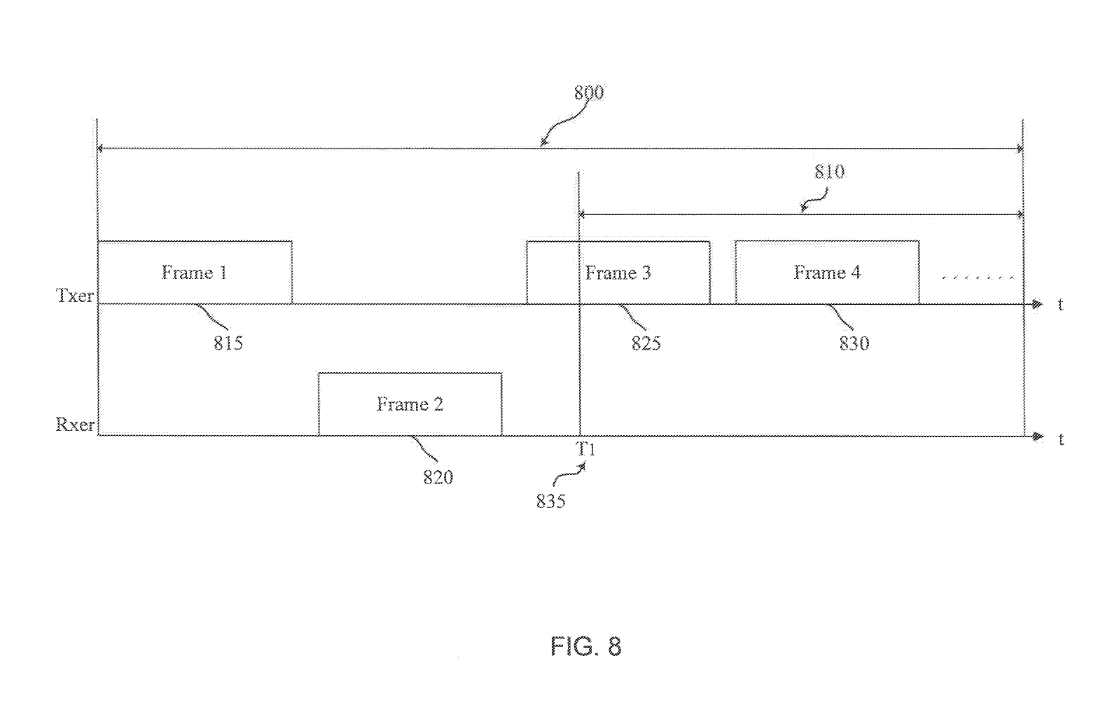

FIG. 8 illustrates details of a TXOP 800 in accordance with one aspect of the present disclosure. TXOP 800 may include one or more OBSS frames. In TXOP 800, a soliciting node (Txer) may transmit a frame 815, a responding node (Rxer) may transmit a frame 820, and the Txer may further transmit a frame 825. Txer and Rxer may be APs 105, or STAs 115 as provided in FIGS. 1 and 2, or any other network devices capable of transmitting and receiving signals, information, or data. In Mode 4, frame 815 may be a legacy request to send (L-RTS) frame, or a legacy data frame, frame 820 may be a L-CTS frame or a legacy acknowledge frame, and third frame 825 may be an enhanced frame. The enhanced frame may be an 802.11ax frame, or other frames under 802.11 standards. In the L-RTS frame, a soliciting node may transmit L-RTS information. In the L-CTS frame, a responding node may transmit L-CTS information. In the legacy data frame, a soliciting node may transmit legacy data. In the legacy acknowledge frame, a soliciting node may transmit acknowledge message in response to the status of receiving data transmissions. However, L-RTS frame, L-CTS frame, legacy data frame, or legacy acknowledgment frame may not carry SR information. As such, in Mode 4, a reusing node may obtain SR information on the enhanced frame.

In order to determine whether to transmit in TXOP 800, a reusing node for Mode 4 may obtain SR information from the soliciting node on frame 825, perform a reuse check for frame 820, and perform an additional check for frames 815 and 825. The additional check may be performed by obtaining at least one threshold, such as a CCA threshold, or an interference threshold, and comparing such threshold with an RSSI of frames 815 and 825, or an estimated interference to the senders of frames 815 and 825. In some cases, an additional check for frames 815 and 825 may pass when RSSIs of frames 815 and 825 are below a predetermined CCA threshold. In other cases, an additional check for frames 815 and 825 may pass when estimated interferences to the senders of frames 815 and 825 are below a predetermined interference threshold. Oppositely, an additional check may not pass when RSSIs of frames 815 and 825 are above a predetermined CCA threshold, or when estimated interferences to the senders of frames 815 and 825 are above a predetermined interference threshold. The threshold may be obtained from received SR information in frame 825, a preamble of frame 815 or a preamble of frame 820, or determined by a reusing node.

A reusing node my reuse duration 810 in response to the determining the reuse check passes for frame 820, and the additional check passes for frames 815 and 825. Duration 810 may start from T₁ 835, at which both a reuse check and an additional check are determined to pass, and end at the end of TXOP 800. Alternatively, duration 810 may end before the end of TXOP 800 in accordance with the obtained SR information. Duration 810 may include the remaining time period in frame 825 after the completion of reuse check and additional check, and any subsequent OBSS frames in TXOP 800, such as frame 830 and OBSS frames after frame 830.

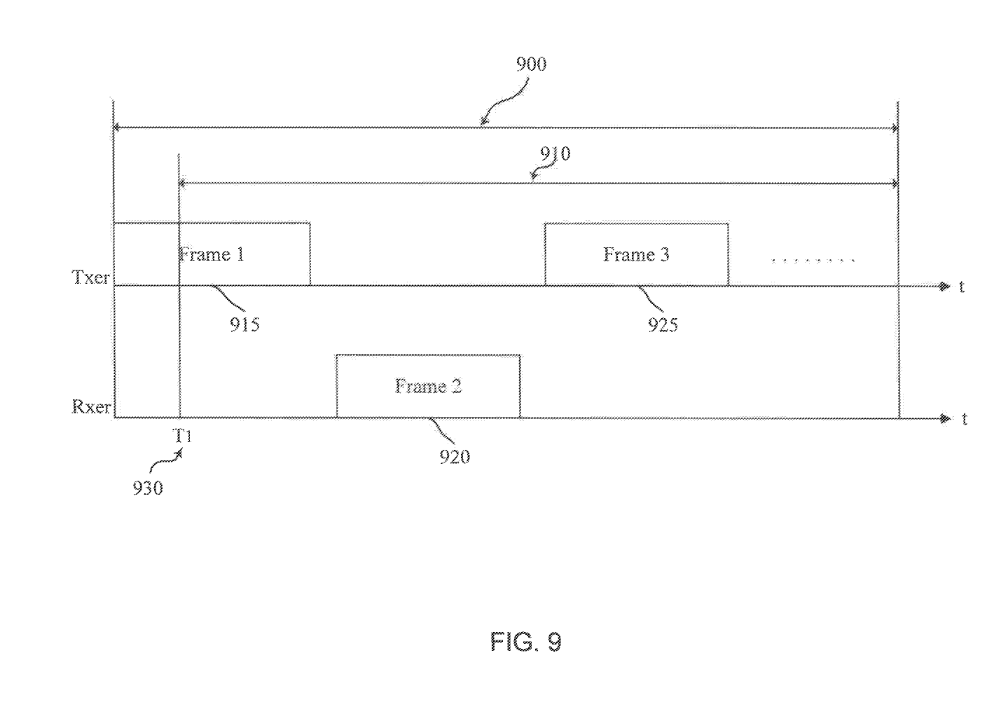

FIG. 9 illustrates details of a TXOP 900 in accordance with one aspect of the present disclosure. TXOP 900 may include one or more OBSS frames. In TXOP 900, a soliciting node may transmit a frame 915. In Mode 5, frame 915 may be an enhanced frame that carriers SR information. The enhanced frame may be an 802.11ax frame, or other frames under 802.11 standards. In order to determine whether to transmit in TXOP 900, a reusing node for Mode 5 may obtain SR information from the soliciting node on frame 915, perform a reuse check for frame 915, and determine whether a reusing indicator is signaled on frame 915. The reusing indicator may be part of SR information of frame 915. The reusing indicator may be one (1) bit in SR information field of HE-SIG-A. A reusing node may reuse duration 910 in response to the determining the reuse check passes for frame 915, and the reusing indicator is signaled on frame 915. Duration 910 may start from T₁ 930, at which a reuse check has been determined to pass and a reusing indicator has been determined to be signaled, and end at the end of TXOP 900. Alternatively, duration 910 may end before the end of TXOP 900 in accordance with the obtained SR information. Duration 910 may include the remaining time period in frame 915 after T₁ 930, and any subsequent OBSS frames in TXOP 900, such as frames 920 and 925 and OBSS frames after frame 925. During frames 920 and 925, a soliciting node, a responding node, or a reusing node may send transmissions.

FIG. 10 illustrate a block diagrams of a reusing node 1000 in accordance with one aspect of the present disclosure. Reusing node 1000 may be an access point, or a station, such as APs 105 and STAs 115 in FIGS. 1 and 2. Reusing node 1000 may include various components including an antenna 1005, a transceiver 1010, a memory 1015, software 1020, a processor 1025, a SR information obtaining module 1030, a reuse checking module 1035, and a TXOP reusing module 1040. Each of these components may communicate, directly or indirectly, with one another (e.g., via one or more buses). Transceiver 1010 may communicate bi-directionally, via one or more antennas, wired, or wireless links, with one or more networks, as described above. For example, transceiver 1010 may communicate bi-directionally with an AP 105 or an STA 115. Transceiver 1010 may also include a modem to modulate the packets and provide the modulated packets to the antennas for transmission, and to demodulate packets received from the antennas. In some cases, Reusing node 1000 may include a single antenna 1005. However, in some cases Reusing node 1000 may have more than one antennas 1005, which may be capable of concurrently transmitting or receiving multiple wireless transmissions.

Memory 1015 may include RAM and ROM. Memory 1015 may store computer-readable, computer-executable software including instructions that, when executed, cause the processor to perform various functions described herein. For example, memory 1015 may store data and program codes for execution of SR information obtaining module 1030, reuse checking module 1035, and TXOP reusing module 1040. SR information obtaining module 1030 may be executed to obtain SR information from a soliciting node and/or a responding node. Reuse checking module 1035 may be executed to perform a reuse check based on the obtained SR information for a transmission opportunity. Reuse checking module 1035 may be further executed to determine whether the reuse check passes for at least one OBSS frame in the transmission opportunity based on at least one predetermined level in the obtained SR information. TXOP reusing module may be executed to reuse one or more remaining OBSS frames of the transmission opportunity after the at least one OBSS frame and any portion of the at least one OBSS frame after the determining the reuse heck passes in response to the determining that the reuse check passes for the at least one OBSS frame. Processor 1025 may include an intelligent hardware device, (e.g., a CPU, a microcontroller, an ASIC, etc.)

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The functional blocks and modules in FIGS. 4 and 10 may comprise processors, electronics devices, hardware devices, electronics components, logical circuits, memories, software codes, firmware codes, etc., or any combination thereof.

Those of skill would further appreciate that the various illustrative logical blocks, modules, circuits, and algorithm steps described in connection with the disclosure herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure. Skilled artisans will also readily recognize that the order or combination of components, methods, or interactions that are described herein are merely examples and that the components, methods, or interactions of the various aspects of the present disclosure may be combined or performed in ways other than those illustrated and described herein.

The various illustrative logical blocks, modules, and circuits described in connection with the disclosure herein may be implemented or performed with a general-purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the disclosure herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

In one or more exemplary designs, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. Computer-readable storage media may be any available media that can be accessed by a general purpose or special purpose computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code means in the form of instructions or data structures and that can be accessed by a general-purpose or special-purpose computer, or a general-purpose or special-purpose processor. Also, a connection may be properly termed a computer-readable medium. For example, if the software is transmitted from a website, server, or other remote source using a coaxial cable, fiber optic cable, twisted pair, or digital subscriber line (DSL), then the coaxial cable, fiber optic cable, twisted pair, or DSL, are included in the definition of medium. Disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of computer-readable media.

As used herein, including in the claims, the term “and/or,” when used in a list of two or more items, means that any one of the listed items can be employed by itself, or any combination of two or more of the listed items can be employed. For example, if a composition is described as containing components A, B, and/or C, the composition can contain A alone; B alone; C alone; A and B in combination; A and C in combination; B and C in combination; or A, B, and C in combination. Also, as used herein, including in the claims, “or” as used in a list of items prefaced by “at least one of” indicates a disjunctive list such that, for example, a list of “at least one of A, B, or C” means A or B or C or AB or AC or BC or ABC (i.e., A and B and C) or any of these in any combination thereof.

The previous description of the disclosure is provided to enable any person skilled in the art to make or use the disclosure. Various modifications to the disclosure will be readily apparent to those skilled in the art, and the generic principles defined herein may be applied to other variations without departing from the spirit or scope of the disclosure. Thus, the disclosure is not intended to be limited to the examples and designs described herein but is to be accorded the widest scope consistent with the principles and novel features disclosed herein.

What is claimed is:

1. A method of wireless communication, comprising:
obtaining spatial reuse (SR) information from one or more nodes;
performing a reuse check based on the obtained SR information for a transmission opportunity, wherein the performing includes determining whether the reuse check passes for at least one overlapping basic service set (OBSS) frame in the transmission opportunity based on at least one predetermined level in the obtained SR information; and
reusing one or more remaining OBSS frames of the transmission opportunity after the at least one OBSS frame and any portion of the at least one OBSS frame after the determining the reuse check passes in response to the determining that the reuse check passes for the at least one OBSS frame.

2. The method of claim 1, wherein the at least one OBSS frame includes an enhanced request to send (e-RTS) frame and an enhanced clear to send (e-CTS) frame.

3. The method of claim 2, wherein the reusing includes reusing the one or more remaining OBSS frames after the e-CTS frame in the transmission opportunity in response to the determining that the reuse check passes for the e-RTS frame and the e-CTS frame.

4. The method of claim 2, wherein the reusing includes reusing one of the one or more remaining OBSS frames after the e-CTS frame in the transmission opportunity and any portion of the e-CTS frame after the determining the reuse check passes for the e-CTS frame in response to the determining that the reuse check only passes for the e-CTS frame.

5. The method of claim 2, wherein the obtaining includes obtaining the SR information from the one or more nodes on the e-RTS frame and the e-CTS frame.

6. The method of claim 1, wherein the at least one OBSS frame includes two or more of: a trigger frame, a solicited frame, or an enhanced frame.

7. The method of claim 6, further comprising determining at least one threshold, wherein the at least one threshold includes one or more of: a clear channel assessment (CCA) threshold or an interference threshold.

8. The method of claim 7, wherein the determining the at least one threshold includes one or more of:
obtaining the at least one threshold on one or more of: the trigger frame, the solicited frame, or the enhanced frame; or
determining the at least one threshold by a reusing node.

9. The method of claim 7, wherein the reusing includes reusing the one or more remaining OBSS frames after the solicited frame in the transmission opportunity and any portion of the solicited frame after the determining the reuse check passes for the solicited frame in response to the determining that the reuse check passes for the solicited frame and one or more of:
determining a received signal strength indicator (RSSI) on the trigger frame is below the CCA threshold; or
determining an estimated interference to a soliciting node of the one or more nodes on the trigger frame is below the interference threshold.

10. The method of claim 9, wherein the determining that the reuse check passes for the solicited frame includes determining the RSSI on the solicited frame, during which legacy clear to send information is transmitted by multiple responding nodes of the one or more nodes.

11. The method of claim 7, wherein in response to the determining that the reuse check passes for the trigger frame and one or more of:
determining a received signal strength indicator (RSSI) on the solicited frame is below the CCA threshold; or
determining an estimated interference to a responding node of the one or more nodes on the solicited frame is below the interference threshold,
the reusing includes reusing the one or more remaining OBSS frames after the solicited frame in the transmission opportunity and any portion of the solicited frame after the determining the RSSI or the estimated interference.

12. The method of claim 11, wherein the determining the RSSI includes determining the RSSI on the solicited frame, during which data is transmitted by multiple responding nodes of the one or more nodes.

13. The method of claim 7, wherein in response to the determining that the reuse check passes for solicited frame and one or more of:
determining received signal strength indicators (RSSIs) on the trigger frame and the enhanced frame are below the CCA threshold; or
determining estimated interferences to the one or more nodes on the trigger frame and the enhanced frame are below the interference threshold,
the reusing includes reusing the one or more remaining OBSS frames after the enhanced frame in the transmission opportunity and any portion of the enhanced frame after determining the RSSIs or the estimated interferences.

14. The method of claim 1, wherein the at least one OBSS frame includes an enhanced frame, the method further comprising:
determining whether a reusing indicator is signaled on the enhanced frame, wherein the reusing includes reusing the one or more remaining OBSS frames after the enhanced frame in the transmission opportunity and any portion of the enhanced frame after the determining the reuse check passes for the enhanced frame and the reusing indicator is signaled on the enhanced frame in response to the determining that the reuse check passes for the enhanced frame and determination that the reusing indicator is signaled on the enhanced frame.

15. An apparatus configured for wireless communication, comprising:
means for obtaining spatial reuse (SR) information from one or more nodes;
means for performing a reuse check based on the obtained SR information for a transmission opportunity, wherein the means for performing includes means for determining whether the reuse check passes for at least one overlapping basic service set (OBSS) frame in the transmission opportunity based on at least one predetermined level in the obtained SR information; and
means for reusing one or more remaining OBSS frames of the transmission opportunity after the at least one OBSS frame and any portion of the at least one OBSS frame after the means for determining the reuse check passes in response to determination that the reuse check passes for the at least one OBSS frame.

16. A non-transitory computer-readable medium having program code recorded thereon, the program code comprising:
program code for causing a computer to obtain spatial reuse (SR) information from one or more nodes;
program code for causing the computer to perform a reuse check based on the obtained SR information for a transmission opportunity, wherein the program code for causing the computer to perform includes program code for causing the computer to determine whether the reuse check passes for at least one overlapping basic service set (OBSS) frame in the transmission opportunity based on at least one predetermined level in the obtained SR information; and
program code for causing the computer to reuse one or more remaining OBSS frames of the transmission opportunity after the at least one OBSS frame and any portion of the at least one OBSS frame after execution of the program code for causing the computer to determine the reuse check passes in response to determination that the reuse check passes for the at least one OBSS frame.

17. An apparatus configured for wireless communication, the apparatus comprising:
at least one processor; and
a memory coupled to the at least one processor,
wherein the at least one processor is configured:
to obtain spatial reuse (SR) information from one or more nodes;
to perform a reuse check based on the obtained SR information for a transmission opportunity, wherein the configuration to perform includes configuration of the at least one processor to determine whether the reuse check passes for at least one overlapping basic service set (OBSS) frame in the transmission opportunity based on at least one predetermined level in the obtained SR information; and
to reuse one or more remaining OBSS frames of the transmission opportunity after the at least one OBSS frame and any portion of the at least one OBSS frame after execution of the configuration to determine the reuse check passes in response to determination that the reuse check passes for the at least one OBSS frame.

18. The apparatus of claim 17, wherein the at least one OBSS frame includes an enhanced request to send (e-RTS) frame and an enhanced clear to send (e-CTS) frame.

19. The apparatus of claim 18, wherein the configuration of the at least one processor to reuse includes configuration to reuse the one or more remaining OBSS frames after the e-CTS frame in the transmission opportunity in response to determination that the reuse check passes for the e-RTS frame and the e-CTS frame.

20. The apparatus of claim 18, wherein the configuration of the at least one processor to reuse includes configuration to reuse one of the one or more remaining OBSS frames after the e-CTS frame in the transmission opportunity and any portion of the e-CTS frame after determination the reuse check passes for the e-CTS frame in response to determination that the reuse check only passes for the e-CTS frame.

21. The apparatus of claim 18, wherein the configuration of the at least one processor to obtain includes configuration to obtain the SR information from the one or more nodes on the e-RTS frame and the e-CTS frame.

22. The apparatus of claim 18, wherein the at least one OBSS frame includes two or more of: a trigger frame, a solicited frame, or an enhanced frame.

23. The apparatus of claim 22, further comprising configuration of the at least one processor to determine at least one threshold, wherein the at least one threshold includes one or more of: a clear channel assessment (CCA) threshold or an interference threshold.

24. The apparatus of claim 23, wherein the configuration of the at least one processor to determine the at least one threshold includes configuration of the at least one processor to one or more of:
obtain the at least one threshold on one or more of: the trigger frame, the solicited frame, or the enhanced frame; or
to determine the at least one threshold by a reusing node.

25. The apparatus of claim 23, wherein the configuration of the at least one processor to reuse includes configuration to reuse the one or more remaining OBSS frames after the solicited frame in the transmission opportunity and any portion of the solicited frame after determination the reuse check passes for the solicited frame in response to determination that the reuse check passes for the solicited frame and execution of a configuration of the at least one processor to one or more of:
determine a received signal strength indicator (RSSI) on the trigger frame is below the CCA threshold; or
determine an estimated interference to a soliciting node of the one or more nodes on the trigger frame is below the interference threshold.

26. The apparatus of claim 25, wherein the configuration of the at least one processor to determine that the reuse check passes for the solicited frame includes configuration to determine the RSSI on the solicited frame, during which legacy clear to send information is transmitted by multiple responding nodes of the one or more nodes.

27. The apparatus of claim 23, wherein in response to determination that the reuse check passes for the trigger frame and execution of a configuration of the at least one processor to one or more of:
determine a received signal strength indicator (RSSI) on the solicited frame is below the CCA threshold; or
determine an estimated interference a responding node of the one or more nodes on the solicited frame is below the interference threshold,
the configuration of the at least one processor to reuse includes configuration to reuse the one or more remaining OBSS frames after the solicited frame in the transmission opportunity and any portion of the solicited frame after execution of the configuration of the at least one processor to determine of the RSSI or the estimated interference.

28. The apparatus of claim 27, wherein the configuration of the at least one processor to determine the RSSI includes configuration to determine the RSSI on the solicited frame, during which data is transmitted by multiple responding nodes of the one or more nodes.

29. The apparatus of claim 23, wherein in response to determination that the reuse check passes for solicited frame and execution of a configuration of the at least one processor to one or more of:
determine received signal strength indicators (RSSIs) on the trigger frame and the enhanced frame are below the CCA threshold; or
determine estimated interferences to the one or more nodes on the trigger frame and the enhanced frame are below the interference threshold,
the configuration of the at least one processor to reuse includes configuration to reuse the one or more remaining OBSS frames after the enhanced frame in the transmission opportunity and any portion of the enhanced frame after execution of the configuration of the at least one processor to determine the RSSIs or the estimated interferences.

30. The apparatus of claim 17, wherein the at least one OBSS frame includes an enhanced frame, the apparatus further comprising:
configuration of the at least one processor to determine whether a reusing indicator is signaled on the enhanced frame, wherein the configuration of the at least one processor to reuse includes configuration to reuse the one or more remaining OBSS frames after the enhanced frame in the transmission opportunity and any portion of the enhanced frame after determination the reuse check passes for the enhanced frame and the reusing indicator is signaled on the enhanced frame in response to determination that the reuse check passes for the enhanced frame and determination that the reusing indicator is signaled on the enhanced frame.
